(19) United States
(12) Patent Application Publication
(10) Pub. No.: US 2019/0243578 A1
(43) Pub. Date: Aug. 8, 2019

(54) MEMORY BUFFER MANAGEMENT FOR SOLID STATE DRIVES

(71) Applicant: Toshiba Memory Corporation, Tokyo (JP)

(72) Inventors: Leland Thompson, Tustin, CA (US); Gordon Waidhofer, Irvine, CA (US); Neil Buxton, Berkshire (GB)

(21) Appl. No.: 15/891,907

(22) Filed: Feb. 8, 2018

(51) Int. Cl. G06F 3/06

(52) U.S. Cl. CPC G06F 3/0656; G06F 3/068; G06F 3/0659; G06F 3/0604

(57) ABSTRACT

In one embodiment, an implementation of a solid state drive (SSD) enables efficient use of volatile memory capacity by receiving data from a host interface communicatively coupled to an SSD, storing the data in one of a plurality of units comprising free memory within a volatile memory within the SSD, writing the data stored in the unit of the volatile memory to a memory buffer within a non-volatile memory within the SSD, and identifying the unit of the volatile memory as free memory after writing the data stored in the unit of the volatile memory to the memory buffer within the non-volatile memory. In one embodiment, the data is protected using a reliability mechanism. In another embodiment, a parity value associated with the data is calculated while transferring the data from the unit of the volatile memory to the memory buffer.

### FIELD OF THE INVENTION

This invention generally relates to an implementation of a solid state drive (SSD) that enables efficient use of volatile memory capacity.

### BACKGROUND OF THE INVENTION

A typical SSD includes non-volatile NAND media (comprised of memory blocks and pages capable of retaining data when power is disconnected), a controller, and an interface (e.g., PCIe, SAS, SATA, or any other interface). The SSD controller of a NAND SSD translates logical addresses from a host interface (e.g., logical read and write commands from a computer) to low-level flash operations (e.g. read, program, and erase) for the associated physical block and page addresses of the NAND SSD. The SSD controller also performs numerous other functions, including, for example: error code correction; garbage collection; scheduling; managing over-provisioning; and wear-leveling. Because the SSD controller of NAND SSDs can accommodate the logical interface of host interfaces, NAND SSDs easily integrate with standard hard disk drive (HDD) compatible interfaces and offload overhead that would otherwise be needed for the host interface to perform such functions.

A traditional host interface HDD interface is not capable of taking full advantage of the performance of a NAND SSD. For example, the host interface is not capable of issuing low-level commands that govern how data is programmed and erased in the SSD and the SSD is not aware of when the host interface will issue read or write commands. Accordingly, both the SSD controller and the host interface employ best effort approaches for performing their independent functions, which results in inefficient utilization of SSD resources, including inefficient use of volatile memory and unpredictable data storage and increased wear-leveling of NAND memory.

In a traditional NAND SSD, when a host interface sends a write command, the SSD controller may store the corresponding data in a temporary memory buffer (e.g., in volatile memory) until the data is programmed or written to NAND memory. The data is not released from the temporary memory buffer until the write or program command completes. When using volatile memory, the fast storage and access times are not efficiently utilized by holding data in the temporary memory buffer until the data is permanently stored in the NAND SSD. Additionally, when the SSD controller stores the data associated with the write command in the temporary memory buffer, the SSD controller may return an acknowledgement signal to the host interface confirming that the data was written or programmed. Accordingly, the host interface functions as if the SSD executed the write command. Further, if a loss of power occurs before the SSD is able to permanently write the data to the NAND SSD, when the host interface requests that data upon a subsequent power-up, out of date or incorrect data may be returned by the SSD controller, unless provision is made for backup power to ensure data is permanently written in the event of main power loss.

Accordingly, there is an unmet demand for a system that can efficiently manage volatile memory resources of a SSD to increase the efficiency of processing commands from a host interface.

### BRIEF DESCRIPTION OF THE INVENTION

In one embodiment, a method of implementing a SSD includes receiving data from a host interface communicatively coupled to an SSD, storing the data in one of a plurality of units comprising free memory within a volatile memory within the SSD, writing the data stored in the unit of the volatile memory to a memory buffer within a non-volatile memory within the SSD, and identifying the unit of the volatile memory as free memory after writing the data stored in the unit of the volatile memory to the memory buffer within the non-volatile memory.

In one embodiment, the method includes receiving additional data from the host interface and accumulating the additional data received from the host interface in the unit of the volatile memory until the accumulated data in the unit of the volatile memory has a capacity equivalent to a unit of the non-volatile memory. In another embodiment, the method includes receiving additional data from the host interface and accumulating the data and the additional data received from the volatile memory in the memory buffer until the accumulated data in the memory buffer has a capacity equivalent to a unit of the non-volatile memory.

In one embodiment, the method includes protecting the data using a reliability mechanism. In one embodiment, the method includes calculating a parity value associated with the data while transferring the data from the unit of the volatile memory to the memory buffer.

In one embodiment the method includes maintaining a list identifying each unit of the volatile memory identified as free memory and ordering each unit of the volatile memory identified as free memory with the list in the order each unit is identified as free memory. In one embodiment, the method includes receiving additional data from the host interface, allocating a unit of the volatile memory identified in the list in the order maintained in the list, and storing the additional data in the allocated unit of the volatile memory.

In one embodiment, an SSD includes a SSD controller communicatively coupled to a host interface, a volatile memory communicatively coupled to the SSD controller, a non-volatile memory communicatively coupled to the SSD controller, and a memory buffer within the non-volatile memory. The SSD controller is configured to store data received from the host interface in one of plurality of units comprising free memory within the volatile memory, write the data stored in the unit of the volatile memory to the memory buffer, and identify the unit of the volatile memory as free memory after writing the data stored in the unit of the volatile memory to the memory buffer.

In one embodiment, the SSD controller receives additional data from the host interface and accumulates the additional data in the unit of the volatile memory until the accumulated data in the unit of the volatile memory has a capacity equivalent to a unit of the non-volatile memory. In another embodiment, the SSD controller receives additional data from the host interface and accumulates the data and the additional data received from the volatile memory in the memory buffer until the accumulated data in the memory buffer has a capacity equivalent to a unit of the non-volatile memory.

In one embodiment, the unit of the non-volatile memory is equivalent in capacity to a page of the non-volatile memory. In another embodiment, the unit of the non-volatile memory is equivalent in capacity to a block of the non-volatile memory.

In one embodiment, the data is protected by a reliability mechanism. In one embodiment, the reliability mechanism is RAIDS and the SSD controller calculates a parity value associated with the data. In one embodiment, the SSD controller stores the calculated parity value in the volatile memory. In another embodiment, the SSD controller stores the calculated parity value in the non-volatile memory. In one embodiment, the SSD controller calculates the parity value while the SSD controller transfers the data from the unit of the volatile memory to the memory buffer.

In one embodiment, the SSD controller maintains a list identifying each unit of the volatile memory identified as free memory and orders each unit of the volatile memory identified as free memory within the list in the order each unit is identified as free memory. In one embodiment, when the SSD controller receives additional data from the host interface, the SSD controller allocates a unit of the volatile memory identified in the list in the order maintained in the list, and stores the additional data in the allocated unit of the volatile memory.

### BRIEF DESCRIPTION OF THE FIGURES

FIG. 1 is a block diagram of one embodiment of an SSD that efficiently uses volatile memory capacity.

FIG. 2 is a block diagram of one embodiment of an SSD that efficiently uses volatile memory capacity.

FIG. 3 is a flow chart of steps for one embodiment of an SSD that efficiently uses volatile memory capacity.

FIG. 4 is a flow chart of steps for one embodiment of an SSD that efficiently uses volatile memory capacity.

### DETAILED DESCRIPTION OF THE INVENTION

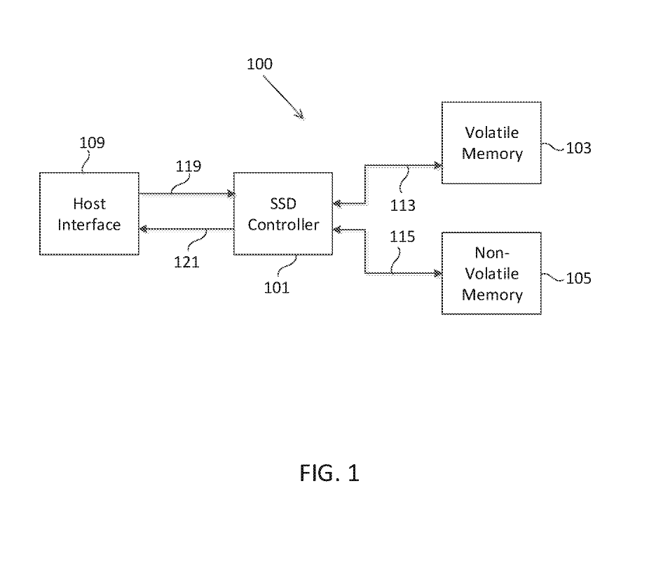

FIG. 1 is a block diagram illustrating one embodiment of an SSD 100 that efficiently uses volatile memory capacity. SSD controller 101 communicates with non-volatile memory 105 through connection 115 and volatile memory 103 through connection 113. Non-volatile memory 105 can be, but is not limited to, an EEPROM, NAND, NOR, MRAM, PCM, PCME, PRAM, PCRAM, PMC, RRAM, NRAM, Ovonic Unified Memory, Chalcogenide Ram, C-RAM, and/or any other type of non-volatile memory known in the art, and volatile memory 103 can be, but is not limited to, DRAM, SRAM, T-RAM, Z-RAM, and/or any other type of volatile memory known in the art. SSD controller 101 stores and retrieves data from the volatile memory 103 during normal operation to allow quick access of data during run time. SSD controller 101 may periodically store data in the non-volatile memory 105 as well.

SSD controller 101 receives commands, including, for example, write and read commands (among others) from a host (not shown) via a host interface 109. The SSD controller 101 temporarily buffers commands and/or data received via the host interface 109 in volatile memory 103. If the command received via host interface 109 is a write command, SSD controller 101 stores the command in a command queue and buffers the associated data in volatile memory 103 until the write command can be executed by SSD controller 101 and the data can be written to non-volatile memory 105.

In one embodiment, the write command and associated data are stored in volatile memory 103 until the SSD controller 101 is able to execute the write command and store the data in non-volatile memory 105. In another embodiment, SSD controller 101 transfers the write command and the associated data buffered in volatile memory 103 to a memory buffer in non-volatile memory 105. When the write command and associated data are transferred to the memory buffer in non-volatile memory 105, the portion of memory used for buffering such command and associated data in volatile memory 103 is released so that SSD controller 101 can use the released portion of volatile memory 103 to buffer additional commands and data received via host interface 109.

In one embodiment, SSD controller 101 reallocates free memory in volatile memory 103 to new commands and associated data received via host interface 109 in the order that the previously allocated memory is freed. For example, if the SSD controller 101 receives three write commands (and associated data) via host interface 109 in the sequence “write 1,” “write 2” and “write 3,” when the SSD controller transfers “write 1” to the memory buffer in non-volatile memory 105, the memory in volatile memory 103 used for “write 1” will be released first, and when SSD controller transfers “write 2” to the memory buffer in non-volatile memory 105, the memory in volatile memory 103 used for “write 2” will be released second. When a portion of memory in volatile memory 103 is released, the portion of memory is marked “free” and is maintained in a list of free memory in the order the memory was freed. The SSD controller 101 will allocate freed memory to the next command, e.g., “write 4” from the host interface 109, in the order that the memory was freed (e.g., some or all of the memory used for “write 1” is allocated to “write 4”). In another embodiment, SSD controller 101 reallocates free memory in volatile memory 103 to new commands and associated data received via host interface 109 using any allocation scheme known the art, including, for example, FIFO, random, or as a memory pool, among many others.

In one embodiment, SSD controller 101 will continue to accumulate data in the memory buffer in non-volatile memory 105 until enough data has accumulated to write a complete page of data (e.g., a 4-kilobyte page) from the memory buffer to the non-volatile memory 105. By releasing portions of volatile memory 103 as soon as data is transferred to the memory buffer in non-volatile memory 105, SSD controller 101 can reuse the released portions of volatile memory 103 at a much faster rate (as opposed to retaining the data in volatile memory 103 until the data is permanently written in non-volatile memory 105). In another embodiment, SSD controller 101 will accumulate data in volatile memory 103 until enough data has accumulated to write a complete page of data (e.g., a 4-kilobyte page) from the volatile memory 103 to non-volatile memory 105. When a complete page of data accumulates in volatile memory 103, SSD controller 101 transfers the data to the memory buffer in non-volatile memory 105 so that the data is subsequently written to non-volatile memory 105. The SSD controller 101 releases the corresponding portion of volatile memory 103 when the data is transferred to the non-volatile memory 105.

Although the descriptions above make reference to accumulating a complete page of data, any capacity of data may be accumulated. In one embodiment, SSD 100 uses a fast operating volatile memory such as SRAM to further increase the speed with which SSD controller 101 buffers commands and data via host interface 109.

When the SSD controller 101 executes a command received from the host interface 109, the SSD controller 101 returns an acknowledgement to the host interface 109. If the command from the host interface 109 is a read command, the SSD controller 101 does not issue an acknowledgement until the read command is performed and the data is returned to the host interface 109. If the command from the host interface 109 is a write command, the SSD controller 101 may issue the acknowledgement signal as soon as the command and corresponding data is stored in the command queue in volatile memory 103, on the assumption that the command will be processed and the data will be stored in non-volatile memory 105. When the SSD controller 101 sends an acknowledgement to the host interface 109 for a write command that has not yet been executed, the SSD controller 101 updates the command queue in volatile memory 103 to indicate that an acknowledgement was sent. When the host interface 109 receives an acknowledgement that certain data was written, the host interface 109 may subsequently send a command to read the data. If SSD controller 101 has not yet written the data to non-volatile memory 105, SSD controller 101 may not be able to execute the read command when the command is received form the host interface 109. In one embodiment, the SSD controller 101 may read the data from the location where the data is temporarily stored (i.e., either volatile memory 103 or the memory buffer in non-volatile memory 105) to satisfy the request from the host. In another embodiment, SSD controller 101 may delay executing the read command from the host interface 109 until after SSD controller 101 writes the data to non-volatile memory 105 (i.e., queue execution of read command to occur after execution of the write command). In another embodiment, SSD controller 101 may return an error to the host interface 109.

If a write command is acknowledged before it is written to the non-volatile memory 105, the data for the write command is critical information if there is a loss of power, as the host interface 109 functions as if the SSD controller 101 executed the write command. Upon a loss of power to SSD 100, all data stored in volatile memory 103 will be lost. Accordingly, if the write command is not executed by the SSD controller 101 before a loss of power, when the host interface 109 requests that data upon a subsequent power-up, out of date or incorrect data may be returned by the SSD controller 101.

In one embodiment, SSD 100 may employ power loss protection through the use of a power circuit configured to supply power to the SSD 100 from a power source during normal operation and backup power from a backup power source in response to a loss of power (as described and illustrated in U.S. patent application Ser. No. 15/142,937. In this embodiment, pending write commands of data stored in volatile memory 103 or in the memory buffer of non-volatile memory 105 can be executed using backup power.

In one embodiment, if a loss of power occurs when a write command and associated data is stored in the memory buffer of non-volatile memory 105 (i.e., before writing the data to the non-volatile memory), after the reapplication of power, the SSD controller 101 may access the memory buffer of non-volatile memory 105 to recover the buffered command and associated data. In another embodiment, after the reapplication of power, the SSD controller 101 may send a request to host interface 109 to recover any commands (and associated data) lost from volatile memory 103 and/or the memory buffer of non-volatile memory 105.

In one embodiment, SSD 100 may use a reliability scheme to protect against the loss of data upon a loss of a power, including, for example, either simple (i.e., a single memory array mapping virtual address to physical page location), mirror (i.e., two or more memory arrays mapping virtual address to physical page location, such that a corrupted memory array can be recovered using one or more of the mirrored memory arrays), RAIDS (i.e., a memory array mapping virtual address to physical page location and parity location, such that corrupted data can be recovered using the parity information), QSBC (Quadruple Swing-by Code) or any other reliability scheme known in the art. If the SSD 100 employs power loss protection, upon a loss of power, the SSD controller 101 may attempt to write the calculated error code correction values to the non-volatile memory 105 during the duration of backup power.

In one embodiment, SSD controller 101 uses RAIDS reliability. For example, if a RAID stripe is comprised of 4 units of data, SSD controller 101 may wait for each of the 4 units of data to accumulate within volatile memory 103. SSD controller 101 then reads each of the 4 units of data from volatile memory 103 and calculates a parity value that can be used to recover lost or corrupted data. SSD controller 101 stores the calculated parity value in volatile memory 103. SSD controller 101 then transfers each of the 4 units of data and the calculated parity value to non-volatile memory 105.

In another embodiment, SSD controller 101 calculates the parity value dynamically. As the SSD controller 101 reads each unit of data from volatile memory 103 to store the unit of data in non-volatile memory 105, the SSD controller 101 accumulates the contribution to the parity value associated with such unit of data. In this embodiment, the parity calculation is complete when the SSD controller 101 has read each of the four units of data from volatile memory 103. The SSD controller 101 then writes the parity calculation to non-volatile memory 105.

In one embodiment, the RAID stripe may comprise any number of units of data. The capacity of a unit of data is equivalent to the capacity of a page, block, any multiple of a page or block, or any other proportion of capacity that may comprise non-volatile memory 105. Additionally, each unit of data may be comprised of one or more commands and/or data from the host interface.

In one embodiment, the RAID stripe comprises four units of data and one parity unit of data. If the SSD controller 101 detects a loss of power before four units of data are written to volatile memory 103, SSD controller 101 may calculate parity by writing garbage to the required additional units of data. For example, if there are only two units of data in volatile memory 103 when a loss of power is detected, SSD controller 101 may write two additional units of data to volatile memory 103 comprised of all “0's,” all “1's,” or any combination of “0's” and “1's.” However, this is not an efficient approach as writing garbage to volatile memory 105 unnecessarily increases wear of volatile memory 105 and requires additional time and power during the duration of backup power. In a preferred embodiment, the SSD controller 101 may calculate intermediate parity by calculating parity for the existing units of data. For example, if there are only two units of data in volatile memory 103 when a loss of power is detected, SSD controller 101 may calculate an intermediate parity value for the two units of data in volatile memory 103. In another embodiment, if additional commands are received via host interface 109 during the duration of backup power and SSD controller 101 determines that there is sufficient time before the termination of backup power, SSD controller 101 may delay calculating the parity value until the additional commands and associated data are written to volatile memory 103. In another embodiment, the RAID stripe may comprise any number of units of data, including, 32, 40, 64, 80, 120, 128, 256, or any other number.

In one embodiment, SSD 100 may be comprised of two volatile memories. The SSD controller 101 may use the first volatile memory to store read commands received via host interface 109 and the second volatile memory to store write commands and associated data from the host interface 109. In another embodiment, the first volatile memory may be comprised of lower capacity fast operating memory (e.g., SRAM memory) and the second volatile memory may be comprised of higher capacity slower operating memory (e.g., SDRAM/DDR memory). In this embodiment, the host interface 109 may prioritize using the SRAM memory for high priority commands and using the DDR memory for lower priority commands. The host interface 109 may assign a priority ranking to each command by sending a corresponding priority signal to SSD controller 101, where, for example, a “1” identifies high priority commands and a “0” identifies low priority commands (or vice versa). In another embodiment, the SSD 100 may be comprised of multiple DDR memory modules in addition to the SRAM memory module such that the cumulative operating frequency of the multiple DDR memory modules is equivalent to the operating frequency of the SRAM memory.

In one embodiment, volatile memory 103 may be an internal component of the host interface 109. In this embodiment, the host interface 109 stores the write command and associated data in volatile memory 103 until enough data has accumulated in volatile memory 103 to write a full page of data to non-volatile memory 105. The host interface 109 can then issue a command for the SSD controller 101 to directly write the data to the non-volatile memory 105 (including any required reliability scheme, e.g., RAIDS). In this embodiment, the SSD controller 101 may send an acknowledgement after the data is written to non-volatile memory 105. If the host interface 109 does not receive an acknowledgement that the data was written to non-volatile memory 105, the host interface 109 assumes that the data was not properly written and may reissue the command to the SSD controller 101.

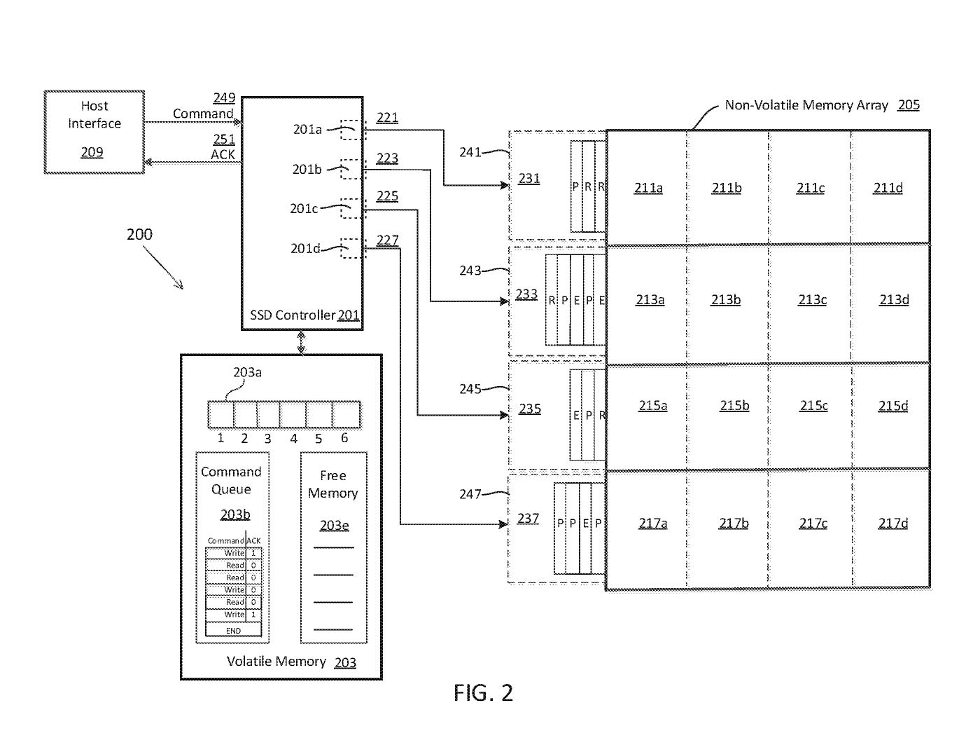

FIG. 2 is a block diagram illustrating one embodiment of an SSD 200 that efficiently uses volatile memory capacity. SSD controller 201 communicates with volatile memory 203 and non-volatile memory 205. The SSD controller 201 uses the volatile memory 203 for temporary storage of commands and data received from a host interface 209. The SSD controller 201 stores in volatile memory 203, units of data 203a, a command queue 203b containing incoming commands from a host interface 209, and a list of free memory 203c. The volatile memory 203 can comprise DRAM, SRAM, T-RAM, Z-RAM and/or any other type of volatile memory known in the art.

SSD controller 201 also communicates with a non-volatile memory 205, which is typically an array organized in banks of non-volatile memory devices 211a-d, 213a-d, 215a-d, and 217a-d, which provide permanent or long-term storage for the data. The non-volatile memory devices 211a-d, 213a-d, 215a-b, and 217a-d can comprise, but is not limited to, an EEPROM, NAND, NOR, MRAM, PCM, PCME, PRAM, PCRAM, PMC, RRAM, NRAM, Ovonic Unified Memory, Chalcogenide Ram, C-RAM, and/or any other type of non-volatile memory known in the art.

In one embodiment, the SSD controller 201 temporarily buffers commands 249 (and associated data) received from the host interface 209 in the volatile memory 203. The SSD controller 201 buffers commands 249 in command queue 203b. The SSD controller 201 also accumulates data corresponding to each command in one or more units of data 203a. For example, if non-volatile memory 205 is comprised of blocks, where each block has a capacity of 128-kilobyes, the volatile memory 203 may be configured such that a single unit of data is equivalent to one 128-kilobyte block. In this example, the SSD controller 201 will cause volatile memory 203 to accumulate data received from the host interface 209 until the capacity of accumulated data is equivalent to 128-kilobytes (e.g., identified in FIG. 2 as unit “1” of units of data 203a). Each of units of data 203a may be configured to be equivalent in capacity to one or more pages or blocks, or any other proportion of capacity that comprises non-volatile memory 205.

In one embodiment, SSD controller 201 transfers commands 249 and the associated data buffered in volatile memory 203 to a memory buffer 241, 243, 245, or 247 in non-volatile memory 205. In one embodiment, SSD controller 201 will continue to accumulate data in the memory buffer 241, 243, 245, or 247 in non-volatile memory 205 until enough data has accumulated to write a complete page of data (e.g., a 4-kilobyte page) from the memory buffer 241, 243, 245, or 247 to the non-volatile memory 205. Although the above description makes reference to accumulating a complete page of data, any capacity of data may be accumulated.

When the SSD controller 201 executes a command 249 received from the host interface 209, the SSD controller 201 returns an acknowledgement, ACK signal 251, to the host interface 209. If the command 249 is a read command, the SSD controller 201 does not issue an acknowledgement, ACK signal 251, until the read command is performed and the data is returned to the host interface 209. If the command 249 is a write command, the SSD controller 201 may issue the acknowledgment, ACK signal 251, as soon as the command is stored in the command queue 203b and the associated data is stored in one or more of units of data 203a, on the assumption that the command will be processed by SSD controller 201 and the data will be stored in non-volatile memory 205. When the SSD controller 201 sends an acknowledgement to the host interface 209 for a write command that has not yet been executed, the SSD controller 201 updates the command queue 203b in the volatile memory 203 to indicate that an acknowledgement was sent (represented by assigning an ACK value of “1” in command queue 203b).

When the host interface 209 receives an acknowledgement that certain data was written, the host interface 209 may subsequently send a command to read the data. If SSD controller 201 has not yet written the data to non-volatile memory 205, SSD controller 201 may not be able to execute the read command when the command is received form the host interface 209. In one embodiment, the SSD controller 201 may read the data from the location where the data is temporarily stored. If the unit of data 203a where the data was stored has not yet been overwritten by new data, SSD controller 201 may return the requested data to the host interface 209 from volatile memory 203. If the unit of data 203a was transferred to one of memory buffers 241, 243, 245, or 247, SSD controller 201 may return the requested data to the host interface 209 from one of memory buffers 241, 243, 245, or 247 of non-volatile memory 205. In one another embodiment, SSD controller 201 may delay executing a read command from the host interface 209 until after SSD controller 201 writes the data to non-volatile memory 205 (i.e., queue execution of read command to occur after execution of the write command). In another embodiment, SSD controller 201 may return an error to the host interface 209.

If a write command is acknowledged by SSD controller 201 before the associated data is written to the non-volatile memory 205, the data for the write command is critical information if there is a loss of power, as the host interface 209 thinks the write command was executed by the SSD controller 201. Upon a loss of power to SSD 200, all data stored in volatile memory 203 will be lost. Accordingly, if SSD controller 201 does not transfer the write command from volatile memory 203 to non-volatile memory 205 before a loss of power, when the host interface 209 requests that data upon a subsequent power-up, out of date or incorrect data may be returned by the SSD controller 201. In one embodiment, if the SSD controller 201 transfers the data to one of the memory buffers 241, 243, 245, or 247 in non-volatile memory 205 prior to the loss of power, the SSD controller 201 may attempt to read the data from the appropriate memory buffer. In another embodiment, SSD controller 201 may return an error to the host interface 209.

The SSD controller 201 begins processing commands in the command queue 203b by reading the associated data from units of data 203a. SSD controller 201 transfers the commands and associated data to non-volatile memory 205 using one or more of memory data channels 221, 223, 225, and 227. SSD controller 209 transfers each of units of data 203a over one memory data channel to non-volatile memory 205. For example, if volatile memory 203 includes four units of data 203a, each of the four units of data 203a may be transferred to non-volatile memory 205 over a single memory channel (e.g., unit of data “1” is transferred over channel 221, unit of data “2” is transferred over channel 223, unit of data “3” is transferred over channel 225, and unit of data “4” is transferred over channel 227). In another embodiment, the non-volatile memory 205 may comprise any number of channels (i.e., one or more). Each channel is controlled independently by a channel controller 201a, 201b, 201c, and 201d within the SSD controller 201 and each channel controller communicates with a corresponding subset of non-volatile memory devices 211a-d, 213a-d, 215a-d, and 217a-d. Within each channel controller 201a-d, there is a channel command queue 231, 233, 235, and 237 that is stored in a respective non-volatile memory buffer 241, 243, 245, and 247. Within each channel command queue 231, 233, 235, and 237, there may be a different mixture of memory commands directed to the corresponding non-volatile memory devices, including read (represented by “R”), write/program (represented by “P”) and erase (represented by “E”). In another embodiment, SSD controller 209 transfers each of units of data 203a over two or more memory data channels to non-volatile memory 205.

In one embodiment, if the command 249 received via host interface 209 is a write command, the command is stored in command queue 203b and the associated data is stored in unit “1” of units of data 203a. The SSD controller 201 uses memory data channel 231 to send the write command to channel command queue 231 and stores the corresponding data in unit “1” of units of data 203a in non-volatile memory buffer 241. The SSD controller 201 does not release the memory corresponding to unit “1” of units of data 203a until the data in unit “1” of units of data 203a is written from non-volatile memory buffer 241 to one or more of non-volatile memory device 211a-d.

In a preferred embodiment, SSD controller 201 releases the memory corresponding to unit “1” of units of data 203a as soon as the SSD controller 201 sends the write command to channel command queue 231 and stores the corresponding data in unit “1” of units of data 203a in non-volatile memory buffer 241. The SSD controller 201 can use the released unit “1” of units of data 203a to store additional data received via host interface 209. By releasing memory used to store data in volatile memory 203 as soon as the data is transferred to one of memory buffers 241, 243, 245 or 247 of non-volatile memory 205, SSD controller 201 can reuse the released portions of volatile memory 203 at a much faster rate than retaining the data in volatile memory 203 until the data is permanently written in non-volatile memory 205. In one embodiment, SSD 200 uses a fast operating volatile memory such as SRAM to further increase the speed with which SSD controller 201 buffers commands and data via host interface 209.

In one embodiment, SSD controller 201 reallocates free units of data 203a in volatile memory 203 to new data received via host interface 209 in the order that the previously allocated memory is freed. For example, if the SSD controller 201 receives three write commands (and associated data) via host interface 209 in the sequence “write 1,” “write 2,” and “write 3,” the data associated with “write 1” may be written to unit “1” of units of data 203a, the data associated with “write 2” may be written to unit “2” of units of data 203a, and the data associated with “write 3” may be written to unit “3” of units of data 203a. When the SSD controller 201 transfers the data associated with “write 1” to memory buffer 231, unit “1” of units of data 203a will be released and will be identified first in a list of free memory 203c. When the SSD controller 201 transfers the data associated with “write 2” to memory buffer 231, unit “2” of units of data 203a will be released and will be identified second in the list of free memory 203c. When the SSD controller 201 receives the next command, “write 4,” from the host interface 209, the SSD controller 201 accesses the list of free memory 203c and allocates memory to “write 4” in the order that the memory was freed (e.g., some or all of the memory used for “write 1” is allocated to “write 4”). In another embodiment, SSD controller 201 reallocates free memory in volatile memory 203 to new commands and associated data received via host interface 209 using any allocation scheme known the art, including, for example, FIFO, random, or as a memory pool, among many others.

In one embodiment, SSD 200 may use a reliability scheme to protect against the loss of data upon a loss of a power, including any reliability scheme known in the art. In one embodiment, SSD controller 201 uses RAIDS reliability. For example, if a RAID stripe is comprised of 4 units of data 203a, SSD controller 201 may wait for each of the 4 units of data 203a to accumulate within volatile memory 203. SSD controller 201 then reads each of the 4 units of data 203a from volatile memory 203 and calculates a parity value that can be used to recover lost or corrupted data. SSD controller 201 stores the calculated parity value as unit “5” of units of data 203a in volatile memory 203. SSD controller 201 then sends each of the five units of data 203a (four units of data 203a comprising the RAID stripe and one unit of data 203a comprising the calculated parity value) over a respective memory channel 221, 223, 225 and 227 for storage in non-volatile memory 205. For example, unit “1” of units of data 203a may be queued in memory buffer 241 using memory channel 221, unit “2” of units of data 203a may be queued in memory buffer 243 using memory channel 223, unit “3” of units of data 203a may be queued in memory buffer 245 using memory channel 225, and unit “4” of units of data 203a may be queued in memory buffer 247 using memory channel 227. Because FIG. 2 illustrates only four memory channels, SSD controller 201 may send the calculated parity value to the non-volatile memory 205 using the memory channel that has the smallest number of pending commands 249 in channel command queue 231, 233, 235 or 237.

In another embodiment, there may be multiple hosts 209 each sending commands 249 to SSD controller 201. SSD controller 201 may allocate a subset of the available number of memory channels to commands from a given host and may send the units of data 203a associated with the given host to the subset of available channels allocated to that host (e.g., memory channels 221 and 223 may be allocated to commands from the first host and memory channels 225 and 227 may be allocated to commands from the second host). In this embodiment, SSD 200 may maximize the distribution of data units comprising a RAID stripe by sending units of data 203a in RAID stripe to different non-volatile memory devices associated with a particular memory channel (e.g., units of data 203a sent over memory data channel 221 may be distributed to non-volatile memory devices 211a-d).

In another embodiment, SSD controller 201 calculates the parity value dynamically. As the SSD controller 201 reads each unit of data 203a from volatile memory 203 to store the unit of data 203a in non-volatile memory 205, the SSD controller 201 accumulates the contribution to the parity value associated with such unit of data 203a. In this embodiment, the parity calculation is complete when the SSD controller 101 has read each of the four units of data 203a from volatile memory 203. The SSD controller 201 then writes the parity calculation to non-volatile memory 205. In one embodiment, the RAID stripe may comprise any number of units of data 203a.

In one embodiment, the RAID stripe comprises four units of data 203a and one parity unit of data 203a. If the SSD controller 201 detects a loss of power before four units of data 203a are written to volatile memory 203, SSD controller 201 may calculate parity by writing garbage to the required additional units of data 203a. For example, if there are only two units of data 203a (unit “1” and unit “2”) in volatile memory 203 when a loss of power is detected, SSD controller 201 may write two additional units of data 203a (unit “3” and unit “4”) to volatile memory 203 comprised of all “0's,” all “1's,” or any combination of “0's” and “1's.” SSD controller 201 can then calculate the parity value for the four units of data 203a. However, this is not an efficient approach as writing garbage to volatile memory 205 unnecessarily increases wear on the volatile memory device 205 and requires additional time and power during the duration of backup power. In a preferred embodiment, the SSD controller 201 may calculate intermediate parity by calculating parity for the existing units of data 203a. For example, if there are only two units of data 203a (unit “1” and unit “2”) in volatile memory 203 when a loss of power is detected, SSD controller 201 may calculate an intermediate parity value for the two units of data in volatile memory 203. In another embodiment, if additional commands 249 are received via host interface 209 during the duration of backup power and SSD controller 201 determines that there is sufficient time before the termination of backup power, SSD controller 201 may delay calculating parity until the additional commands and associated data are written to volatile memory 203.

As described with respect to FIG. 1, other embodiments of SSD 200 include, for example, two or more volatile memories, volatile memory 203 as an internal component of the host interface 209, and power loss protection.

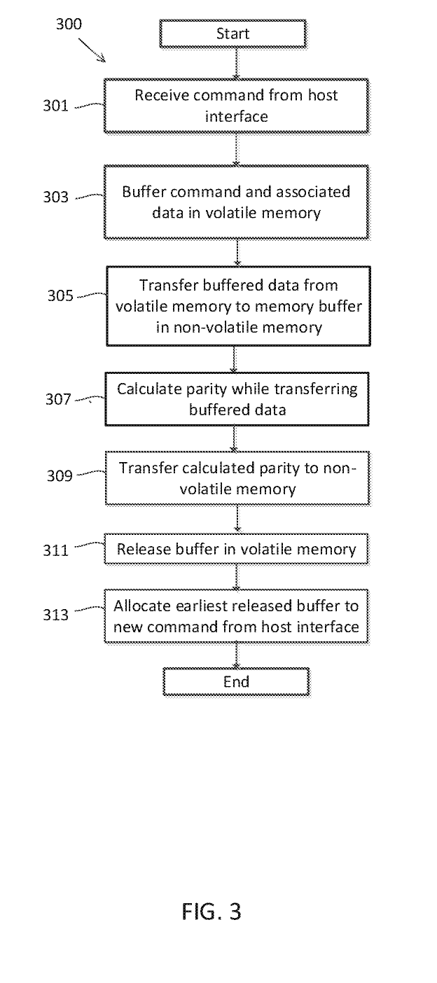

FIG. 3 is a flow chart of steps 300 illustrating one embodiment of an SSD that efficiently uses volatile memory capacity. In this embodiment, RAID parity is calculated while transferring buffered data from volatile memory to a memory buffer in non-volatile memory. As discussed with respect to FIGS. 1 and 2, a SSD controller 101 and 201 temporarily stores commands (and associated data) received from a host interface 109 and 209 in volatile memory 103 and 203 until the SSD controller 101 and 201 transfers the command (and associated data) to a memory buffer of non-volatile memory 105 and 205. Although the following description makes reference to elements of FIG. 2, the method steps are equally applicable to the elements of FIG. 1.

At step 301, SSD controller 201 receives one or more commands 249 (and associated data) from a host interface 209. The commands 249 received via host interface 209 include, for example, read, write/program, and erase commands. If the command 249 received from the host interface 209 is a write command (with associated data), at step 303, SSD controller 201 buffers the command 249 (and associated data) in volatile memory 203. The SSD controller 201 buffers commands 249 in command queue 203b. The SSD controller 201 may also store data corresponding to each command in one or more units of data 203a. For example, if non-volatile memory 205 is comprised of blocks, where each block has a capacity of 128-kilobyes, the volatile memory 203 may be configured such that a single unit of data is equivalent to one 128-kilobyte block.

In one embodiment, at step 303, SSD controller 201 may accumulate data associated with additional commands 249 via host interface 209 in one or more units of data 203a of volatile memory 203 until enough data has accumulated to write a complete page of data (e.g., a 4-kilobyte page) from volatile memory 203 to non-volatile memory 205. Each of units of data 203a may be configured to be equivalent in capacity to one or more pages or blocks, or any other proportion of capacity that comprises non-volatile memory 205.

At step 305, SSD controller 201 transfers buffered data from units of data 203a in volatile memory 203 to a memory buffer 241, 243, 245, or 247 of non-volatile memory 205. If during step 303 SSD controller 201 accumulated one or more complete units of data 203a, SSD controller 201 transfers each of the one or more complete units of data 203a to one or more memory buffers 241, 243, 245, or 247 using corresponding memory channel 221, 223, 225, or 227. For example, if volatile memory 203 includes four units of data 203a, each of the four of data 203a may be transferred to non-volatile memory 205 over a single memory channel (e.g., unit of data “1” is transferred over channel 221, unit of data “2” is transferred over channel 223, unit of data “3” is transferred over channel 225, and unit of data “4” is transferred over channel 227).

If SSD controller 201 does not accumulate data in volatile memory 203 to form one or more complete units of data 203a, at step 303, SSD controller 201 transfers each command 249 (and associated data) stored in volatile memory 203 to a memory buffer 241, 243, 245, or 247 using a corresponding memory channel 221, 223, 225, or 227. In this embodiment, SSD controller 201 accumulates data in each memory buffer 241, 243, 245 or 247 until a full page or block of data has accumulated. When a full page or block of data has accumulated in memory buffer 241, 243, 245, or 247, the memory buffer is able to write a complete page or block of data to non-volatile memory 205. In one embodiment, any capacity of data may be accumulated in memory buffer 241, 243, 245, or 247 and written to non-volatile memory 205.

At step 307, SSD controller 201 calculates a parity value dynamically while transferring buffered data from volatile memory 203 to non-volatile memory 205. In one embodiment, SSD 200 may use RAIDS reliability and a RAID stripe may comprise four units of data 203a and one unit of parity data 203a. For example, as the SSD controller 201 reads each unit of data 203a from volatile memory 203 to store the unit of data 203a in non-volatile memory 205, the SSD controller 201 accumulates the contribution to the parity value associated with such unit of data 203a. In this embodiment, the parity calculation is complete when the SSD controller 201 has read each of the four units of data 203a from volatile memory 203. The SSD controller 201 then writes the parity calculation to non-volatile memory 205. In one embodiment, the RAID stripe may comprise any number of units of data 203a. In one embodiment, if the SSD controller 201 detects a loss of power before four units of data 203a are written to volatile memory 203, SSD controller 201 may calculate intermediate parity for the units of data 203a transferred from volatile memory 203 to one or more memory buffers 241, 243, 245 and/or 247 of non-volatile memory 205.

At step 309, the parity value calculated by SSD controller 201 is transferred to a memory buffer 241, 243, 245, or 247 of non-volatile memory 205. If during step 307, SSD controller 201 calculated an intermediate parity value in response to detecting a loss of power, at step 309, the calculated intermediate parity value is transferred to a memory buffer 241, 243, 245, or 247 of non-volatile memory 205.

At step 311, SSD controller 201 releases the portion of volatile memory 203 corresponding to the command 249 (and associated data) transferred from volatile memory 203 to the one or more memory buffers 241, 243, 245, and/or 247 of non-volatile memory 205 in step 305 or step 315. In one embodiment, SSD controller 201 releases unit “1” of units of data 203a as soon as the SSD controller 201 sends the write command to channel command queue 231 and stores the corresponding data in unit “1” of units of data 203a in non-volatile memory buffer 241. The SSD controller 201 can use the released unit “1” of units of data 203a to store additional data received via host interface 209. By releasing memory used to store data in volatile memory 203 as soon as the data is transferred to one of memory buffers 241, 243, 245, or 247 of non-volatile memory 205, SSD controller 201 can process additional commands 249 (and associated data) at a much faster rate than retaining the data in volatile memory 203 until the data is permanently written in non-volatile memory 205. In one embodiment, SSD controller 201 may perform step 317 at any time between steps 305 and 307, during step 307, between steps 307 and 309, or during step 309.

At step 313, SSD controller allocates free or released data in volatile memory 203 to new data received via host interface 209 in the order that the memory is freed. For example, if the SSD controller 201 receives three write commands (and associated data) via host interface 209 in the sequence “write 1,” “write 2” and “write 3,” the data associated with “write 1” may be written to unit “1” of units of data 203a, the data associated with “write 2” may be written to unit “2” of units of data 203a, and the data associated with “write 3” may be written to unit “3” of units of data 203a. When the SSD controller 201 transfers the data associated with “write 1” to memory buffer 231, unit “1” of units of data 203a will be released and will be identified first in a list of free memory 203c. When the SSD controller 201 transfers the data associated with “write 2” to memory buffer 231, unit “2” of units of data 203a will be released and will be identified second in the list of free memory 203c. When the SSD controller 201 receives the next command, e.g., “write 4,” from the host interface 209, the SSD controller 201 accesses the list of free memory 203c and allocates memory to “write 4” in the order that the memory was freed (e.g., some or all of the memory used for “write 1” is allocated to “write 4”).

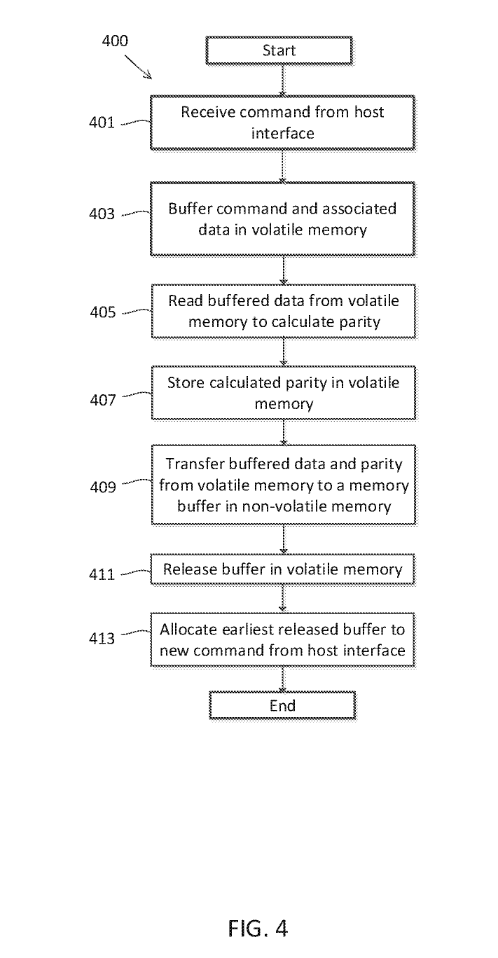

FIG. 4 is a flow chart of steps 400 illustrating one embodiment of an SSD that efficiently uses volatile memory capacity. In this embodiment, RAID parity is calculated and stored in volatile memory before transferring buffered data from volatile memory to a memory buffer in non-volatile memory. As discussed with respect to FIGS. 1 and 2, a SSD controller 101 and 201 temporarily stores commands (and associated data) received from a host interface 109 and 209 in volatile memory 103 and 203 until the SSD controller 101 and 201 transfers the command (and associated data) to a memory buffer of non-volatile memory 105 and 205. Although the following description makes reference to elements of FIG. 2, the method steps are equally applicable to the elements of FIG. 1.

Steps 401 and 403 of FIG. 4 are identical to steps 301 and 303 of FIG. 3. At step 405, SSD controller 201 reads buffered data from volatile memory 203 to calculate a parity value. For example, if SSD controller 201 uses RAIDS reliability and a RAID stripe is comprised of 4 units of data 203a, SSD controller 201 may wait for each of the 4 units of data 203a to accumulate within volatile memory 203. SSD controller 201 then reads each of the 4 units of data 203a from volatile memory 203 and calculates a parity value that can be used to recover lost or corrupted data. In one embodiment, the RAID stripe may comprise any number of units of data 203a. In one embodiment, if the SSD controller 201 detects a loss of power before four units of data 203a are written to volatile memory 203, SSD controller 201 may calculate intermediate parity for the units of data 203a stored in volatile memory 203. At step 407, SSD controller 201 stores the calculated parity value as unit “5” of units of data 203a in volatile memory 203. In one embodiment, if the SSD controller 201 detects a loss of power when only two units of data 203a are stored in volatile memory 203, SSD controller 201 stores the calculated intermediate parity value as unit “3” of units of data 203a. At step 409, SSD controller 201 transfers the buffered data and calculated parity value (or intermediate parity value) from volatile memory 203 to one or more memory buffers 241, 243, 245, and/or 247 in non-volatile memory 205. For example, unit “1” of units of data 203a may be queued in memory buffer 241 using memory channel 221, unit “2” of units of data 203a may be queued in memory buffer 243 using memory channel 223, unit “3” of units of data 203a may be queued in memory buffer 245 using memory channel 225, and unit “4” of units of data 203a may be queued in memory buffer 247 using memory channel 227. Because FIG. 2 illustrates only four memory channels, SSD controller 201 may send the calculated parity data to the non-volatile memory 205 using the memory channel that has the smallest number of pending commands 249 in channel command queue 231, 233, 235, or 237. In one embodiment SSD 200 may have any number of memory channels and corresponding non-volatile memory devices. Steps 411 and 413 of FIG. 4 are identical to steps 311 and 313 of FIG. 3. Other objects, advantages and embodiments of the various aspects of the present invention will be apparent to those who are skilled in the field of the invention and are within the scope of the description and the accompanying Figures. For example, but without limitation, structural or functional elements might be rearranged, or method steps reordered, consistent with the present invention. Similarly, principles according to the present invention could be applied to other examples, which, even if not specifically described here in detail, would nevertheless be within the scope of the present invention.

What is claimed is:

1. A method of implementing a SSD, the method comprising:
receiving data from a host interface communicatively coupled to an SSD;
storing the data in one of a plurality of units comprising free memory within a volatile memory within the SSD;
writing the data stored in the unit of the volatile memory to a memory buffer within a non-volatile memory within the SSD;
identifying the unit of the volatile memory as free memory after writing the data stored in the unit of the volatile memory to the memory buffer within the non-volatile memory.

2. The method of claim 1, further comprising receiving additional data from the host interface and accumulating the additional data received from the host interface in the unit of the volatile memory until the accumulated data in the unit of the volatile memory has a capacity equivalent to a unit of the non-volatile memory.

3. The method of claim 1, further comprising receiving additional data from the host interface and accumulating the data and the additional data received from the volatile memory in the memory buffer until the accumulated data in the memory buffer has a capacity equivalent to a unit of the non-volatile memory.

4. The method of claim 1, further comprising protecting the data using a reliability mechanism.

5. The method of claim 4, further comprising, calculating a parity value associated with the data while transferring the data from the unit of the volatile memory to the memory buffer.

6. The method of claim 1, further comprising, maintaining a list identifying each unit of the volatile memory identified as free memory and ordering each unit of the volatile memory identified as free memory with the list in the order each unit is identified as free memory.

7. The method of claim 6, further comprising, receiving additional data from the host interface, allocating a unit of the volatile memory identified in the list in the order maintained in the list, and storing the additional data in the allocated unit of the volatile memory.

8. A solid state drive (SSD) comprising:
a SSD controller communicatively coupled to a host interface;
a volatile memory communicatively coupled to the SSD controller;
a non-volatile memory communicatively coupled to the SSD controller; and
a memory buffer within the non-volatile memory,
wherein the SSD controller is configured to store data received from the host interface in one of plurality of units comprising free memory within the volatile memory, write the data stored in the unit of the volatile memory to the memory buffer, and identify the unit of the volatile memory as free memory after writing the data stored in the unit of the volatile memory to the memory buffer.

9. The SSD of claim 8, wherein the SSD controller receives additional data from the host interface, and the SSD controller is further configured to accumulate the additional data in the unit of the volatile memory until the accumulated data in the unit of the volatile memory has a capacity equivalent to a unit of the non-volatile memory.

10. The SSD of claim 9, wherein the unit of the non-volatile memory is equivalent in capacity to a page of the non-volatile memory.

11. The SSD of claim 8, wherein the SSD controller receives additional data from the host interface, and the SSD controller is further configured to accumulate the data and the additional data received from the volatile memory in the memory buffer until the accumulated data in the memory buffer has a capacity equivalent to a unit of the non-volatile memory.

12. The SSD of claim 11, wherein the unit of the non-volatile memory is equivalent in capacity to a block of the non-volatile memory.

13. The SSD of claim 8, wherein the data is protected by a reliability mechanism.

14. The SSD of claim 13, wherein the reliability mechanism is RAIDS and wherein the SSD controller is further configured to calculate a parity value associated with the data.

15. The SSD of claim 14, wherein the SSD controller is further configured to store the calculated parity value in the volatile memory.

16. The SSD of claim 14, wherein the SSD controller is further configured to store the calculated parity value in the non-volatile memory.

17. The SSD of claim 14, wherein the SSD controller is further configured to calculate the parity value while the SSD controller transfers the data from the unit of the volatile memory to the memory buffer.

18. The SSD of claim 8, wherein the SSD controller is further configured to maintain a list identifying each unit of the volatile memory identified as free memory and order each unit of the volatile memory identified as free memory within the list in the order each unit is identified as free memory.

19. The SSD of claim 18, wherein the SSD controller receives additional data from the host interface, and the SSD controller is further configured to allocate a unit of the volatile memory identified in the list in the order maintained in the list, and store the additional data in the allocated unit of the volatile memory.

20. The SSD of claim 8, wherein the unit of the volatile memory is equivalent in capacity to a page of the non-volatile memory.
